(19) United States
(12) Patent Application Publication
(10) Pub. No.: US 2006/0255932 A1
(43) Pub. Date: Nov. 16, 2006

(54) Method and Arrangement for Generating a Warning Signal in Two Devices Which are Adapted for Wireless Communication with One Another

(76) Inventors: Christian Kranz, Ratingen-Lintorf (DE); Martin Brandenburg, Muehlheim a. d. Ruhr (DE)

Correspondence Address: BAKER BOTTS, L.L.P., 98 SAN JACINTO BLVD., SUITE 1500, AUSTIN, TX, 78701-4039, US

(21) Appl. No.: 11/279,805

(22) Filed: Apr. 14, 2006

Related U.S. Application Data
(63) Continuation of application No. PCT/DE04/02300, filed on Oct. 15, 2004.

(30) Foreign Application Priority Data
Oct. 16, 2003 (DE) 103 48 204.0

(51) Int. Cl. G08B 1/08

(52) U.S. Cl. 340/539.1; 340/539.21

(57) ABSTRACT

In a method for generating a warning signal in two devices (1, 4) which are adapted for wireless communication, a variable (18) characteristic of the existence of a connection between the resting first device (4) and the second device (1) and/or a variable (10, 11) influenced by the distance between the two devices is monitored. A warning signal is output to the user if the variable (18) characteristic of the existence of the connection shows a behavior typical of the termination of the connection and/or if the variable (10, 11) influenced by the distance between the two devices shows a behavior typical of an increase in the distance between the two devices.

### CROSS-REFERENCE TO RELATED APPLICATION

This application is a continuation of co-pending International Application No. PCT/DE2004/002300 filed Oct. 15, 2004, which designates the United States, and claims priority to German application number DE 103 48 204.0 filed Oct. 16, 2003.

### TECHNICAL FIELD

The invention relates to a method and to an arrangement for generating a warning signal for a user of two devices which are adapted for wireless communication with one another, the first device acting as input and/or output interface between the user and a second device.

### BACKGROUND

Modern input and/or output devices which form an interface between a user and a second device used by the latter are increasingly offered as wirelessly operated devices. Thus, a wireless radio mouse as input device represents an alternative to a computer mouse connected to a computer, for example a laptop, via a cable. Apart from a multiplicity of advantages which wireless systems generally exhibit in comparison with wire-connected systems, the risk with wireless input and/or output devices exists that these are left lying or are lost by the user much more easily than wire-connected input and output devices. Whereas, for example, a wire-connected mouse is usually packed up and carried along during a transportation by the user of a laptop due to the cable between the laptop and the mouse, the wireless mouse can be easily overlooked and forgotten when the laptop is transported. In such a case, the user frequently notices his loss only with the next use.

### SUMMARY

The invention is, therefore, based on the object of specifying a method which reminds the user of two devices which are adapted for wireless communication with one another, the first device acting as input and/or output interface between the user and the second device, not to forget the wireless input and/or output device. Furthermore, the invention has the aim of specifying a corresponding arrangement.

The method according to the invention for generating a warning signal for a user of two devices which are adapted for wireless communication with one another, the first device acting as input and/or output interface between the user and the second device, is arranged in two steps: in a first step, a variable characteristic of the existence of a connection between the resting first device and the second device and/or a variable influenced by the distance between the resting first device and the second device is monitored. In a second step, a warning signal is output to the user if the variable characteristic of the existence of the connection shows a behavior typical of the termination of the connection and/or if the variable influenced by the distance between the two devices shows a behavior typical of an increase in the distance between the two devices.

The two devices are virtually chained together by the method according to the invention. When he recognizes an indication which is characteristic of a spatial removal of the second device from the resting first device, effected by the user presently or in the future, the user is reminded not to forget the resting first device. If the connection between the two devices is terminated, particularly when the second device is switched off, this is an indication to remind the user because after the second device is switched off, the second device, which is generally portable, is not infrequently transported. The termination of the connection in the sense according to the invention can also be recognized already by the sending out of a standard-specific abortion request from the first device before the connection is actually terminated. Furthermore, the increase in distance between the stationary, but still generally portable first device, for example located stationary on a desk surface, and the second device can be an indication to warn the user.

In the sense of the invention, the expression “wireless” also comprises, apart from communication by radio, a connection between the two devices via an infrared interface.

The first device and the second device are advantageously adapted to communicate with one another via a radio network. In this case, the radio network advantageously allows a signal transmission between the second device as transmitter and the first device as receiver. The step of monitoring can thus be advantageously carried out by the first device.

This provides the advantage that the first device can carry out the method independently of the second device. If the second device is switched off, the user can still be reminded even after the second device is switched off, given a corresponding output means in the first device or in a third device.

According to an advantageous embodiment, the variable influenced by the distance between the two devices is the signal strength received in the monitoring device, particularly the field strength and/or signal quality, particularly the bit error rate. In this case, it is of advantage if the behavior typical of an increase in the distance between the two devices is a decrease in the signal strength and/or signal quality.

Normally, the first device is operated at a constant distance from the second device. The signal strength received in the monitoring device, particularly the field strength, and/or the signal quality, particularly the bit error rate, is always of the same order of magnitude in this case. If, however, the received field strength is reduced or the bit error rate is increased, for example, this is typical behavior for an increase in distance between the two devices and thus, with the first device at rest, an indication that the user is moving away with the second device.

According to an advantageous embodiment, the step of outputting the warning signal to the user is carried out by the second device. This provides the advantage that the warning signal is output directly in closest vicinity to the user who is moving away from the resting first device with the second device. In addition, universally used audible or visual signal sources already existing in a second device such as, for example, a signal generator and loudspeaker or a screen or an LED (light emitting diode) in the case of a laptop, can be used.

According to an alternative embodiment, the step of outputting the warning signal to the user is carried out by the first device. For this purpose, the first device comprises in this case an audible or visual signal source. As an alternative, the use of a so-called force feedback signal source is also conceivable, the user being warned by the action of force on him, for example by vibration of the first device. Outputting the warning signal by means of the first device provides the advantage that the first device can output the warning signal independently of the second device. This is of importance, in particular, if the second device is already switched off. In addition, an intelligent peripheral device which carries out the method according to the invention for ensuring its own usefulness largely autonomously of the higher-level second device is created in combination with the additional monitoring performed in the first device.

According to a further alternative embodiment, a connection to a third device, particularly a mobile telephone, is set up before the warning signal is output to the user if the variable characteristic of the existence of the connection between the first and the second device indicates a behavior typical of the termination of the connection and/or if the variable influenced by the distance between the two devices shows a behavior typical of an increase in the distance between the first and the second device. The warning signal is then output by the third device.

The advantage of such a measure lies in that the user can be warned even if there is no longer a line-of-sight connection or audible connection between the user and the first device and if the second device has already been switched off. When the measure is implemented, two possibilities must be emphasized especially, in principle. According to a first possibility, the first or second device starts a connection to a third device, for example a cordless telephone or a mobile telephone via the same or such a radio network via which the first device and the second device are adapted to communicate. If the third device is a mobile telephone, the warning signal could be output via the mobile telephone at any distance of the user from the first device, in principle. For this purpose, according to a second possibility, the first or second device would have to start a connection via a cellular mobile radio network, for example via a GSM network, to the mobile telephone.

The devices which are adapted for communication by radio advantageously operate in accordance with the Bluetooth standard. This has the advantage that Bluetooth-specific characteristics can be utilized in the method according to the invention.

Bluetooth connections between two Bluetooth-compatible devices are duplex connections. This means that, in principle, there is a forward channel and a return channel. In the case of a Bluetooth-compatible radio mouse in which only the forward channel from the radio mouse to the laptop is utilized in conventional input operation, the existence of a return channel can be used for monitoring the signal strength and/or signal quality received in the radio mouse in the sense of the method according to the invention.

In addition, a Bluetooth-specific radio network, called pico network, can comprise more than two devices. In this case, a third device such as, for example, a cordless telephone, can be easily addressed by the first or second device via the pico network, as described above, in order to deliver a warning signal to the user.

Furthermore Bluetooth-compatible devices must be able to measure the field strength and the bit error rate, in any case. The monitoring according to the invention of the field strength or of the bit error rate can, therefore, be performed by means of the Bluetooth-specific measuring means which are already present without any additional dedicated field strength measuring means or bit error rate measuring means.

In the case where the devices adapted to communicate by radio are operating in accordance with the Bluetooth standard, an advantageous application of the invention is obtained if the first and the second device operate in accordance with the Bluetooth-specific HID profile (human interface device). In this arrangement, the first device acts as HID device and the second device acts as HID host. Using the HID profile provides the advantage, that as a result, short latency periods are made possible for the signal transmission between the two devices.

Bluetooth-specific profiles such as, for example, the HID profile specify how Bluetooth protocols are utilized with particular parameters for device-specific tasks. During the registration in a pico network, Bluetooth devices name their profile or profiles to their partners and thus inform them about their capability. In this context, only those devices matching one another are connected which have the same profiles so that matching devices such as radio mouse and laptop or Bluetooth digital camera and laptop communicate with one another, but not radio mouse and Bluetooth digital camera. The Bluetooth-specific HID profile represents a separate profile for communication between two Bluetooth devices, a first device acting as input and/or output interface between the user and the second device. In this arrangement, the first device, for example a radio mouse, generally operates in its role as Bluetooth-specific HID device, the second device, for example a laptop which is connected to the radio mouse, then assuming the role of the Bluetooth-specific HID host.

The arrangement according to the invention for generating a warning signal comprises a means for monitoring a variable characteristic of the existence of a connection between the resting first device and the second device and/or a variable influenced by the distance between the resting first device and the second device. Furthermore, the arrangement contains an output means for outputting a warning signal to the user which is activated in dependence on a behavior typical of the termination of the connection of the variable characteristic of the existence of the connection and/or in dependence on a behavior typical of an increase of the distance between the two devices of the variable influenced by the distance between the two devices.

### BRIEF DESCRIPTION OF THE DRAWINGS

In the text which follows, the invention will be explained in greater detail by means of two exemplary embodiments, referring to the drawings, in which:

FIG. 1 shows a representation of a first exemplary embodiment according to the invention and

FIG. 2 shows a representation of a second exemplary embodiment according to the invention.

### DETAILED DESCRIPTION

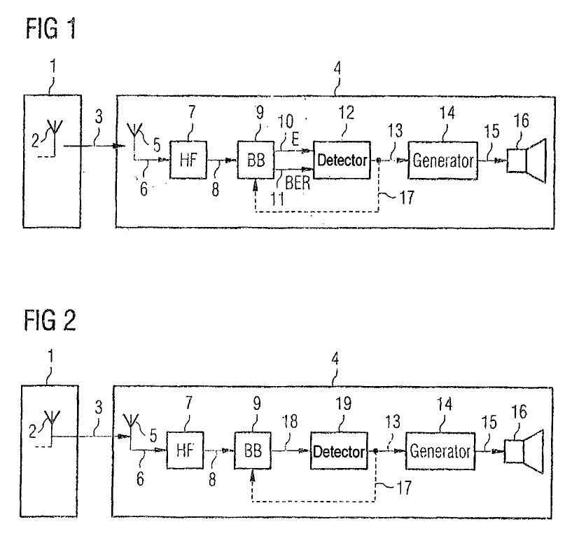

FIG. 1 shows a first exemplary embodiment of the invention. A laptop 1 with a radio interface sends signals, coming from an antenna 2, via an air interface 3 to a radio mouse 4. The radio mouse 4 has an antenna 5 which receives the signals of the air interface 3 and supplies them as antenna signal 6 to a radio-frequency circuit (RF) 7. The radio frequency circuit 7 converts the input signal into a baseband signal 8 which is supplied to a baseband processor (BB) 9. The baseband processor supplies two output signals 10 and 11, output signal 10 being characteristic of the field strength of the received signal and output signal 11 being characteristic of the bit error rate of the received signal. These signals are supplied to a detector circuit 12. The output signal 13 of the detector circuit is fed into a generator circuit 14. The output signal 15 of the generator circuit is supplied to a loudspeaker 16 which converts the signal 15 into audible signals.

Both the laptop 1 and the radio mouse 4 operate in accordance with the wireless Bluetooth standard. The basic principles of Bluetooth transmission are specified in the technical article “Die Bluetooth-Übertragung” (Bluetooth transmission), Jaap Haartsen, Funkschau, 1999, issue No. 15, pages 76 to 80. The content of this reference is herewith included in the content of the disclosure of the present patent application by reference. The Bluetooth standard provides for bidirectional transmission between both devices. In FIG. 1, only the signal transmission in the direction from the laptop 1 to the radio mouse 4 is shown. The signal transmission in the reverse direction which is used for transmitting the mouse motion information is not drawn.

The two devices support the above-mentioned Bluetooth-specific HID profile, the laptop 1 assuming the role of the HID host and the radio mouse 4 assuming the role of the HID device with regard to the HID profile. The fundamentals of the Bluetooth profiles can be found in the technical article “Die Bluetooth-Profile” (The Bluetooth profiles), Dr. Gerd Thiedemann, Funkschau, 2003, volume No. 12, pages 59 and 60. The content of this reference is herewith included in the content of the disclosure of the present application by reference.

The two devices 1 and 4 form a radio network: the so-called Bluetooth-specific pico network. In this network, the laptop 1 acts as so-called master of the network and the radio mouse 4 acts as so-called slave. In this arrangement, the master as higher-level unit, regulates the radio traffic occurring in the network.

If the user then transports the laptop 1 to another location and, in doing so, leaves the mouse 4 at its original location, this is recognized by the arrangement according to the invention and the user is warned. The signal received by the radio mouse is continuously monitored with regard to its field strength and/or bit error rate. The field strength signal 10 characteristic of the field strength of the received signal and the BER signal 11 characteristic of the bit error rate are determined by evaluating the signal received by the antenna. In this arrangement, the field strength of the received electromagnetic signal is basically determined in the radio-frequency circuit 7 by determining the signal swing of the electrical input signal 6. The information about the field strength is generally also available to the digital baseband processor 9 via a corresponding interface (not drawn) between the two components. The bit error rate (BER) of the received signal is determined in the digital baseband processor. Since the field strength, and thus also the field strength signal 10, are variables dependent on the distance between the laptop 1 and the radio mouse 4, the reduction in field strength is an indication that the laptop 1 and the radio mouse 4 are moving away from one another. In the case of a resting radio mouse 4, the laptop 1, and thus also the user, are moving away from the radio mouse 4 when the field strength decreases. If then the field strength decreases by a certain factor, this reduction is detected in the detector circuit 12. As an alternative, it would also be possible that a certain maximum absolute decrease in field strength is detected in the detector 12. When detecting this defined reduction, the detector 12 activates the signal generator 14 which, in consequence, outputs a signal 15 which, after electrical/acoustical conversion reminds the user via the loudspeaker 16 to transport the radio mouse 4 together with the laptop 1. As an alternative to the field strength, the bit error rate also represents a variable dependent on the distance between the laptop 1 and the radio mouse 4, an increase in the BER being an indication that the laptop 1 and the radio mouse 4 are moving away from one another and the user is thus moving away from the radio mouse 4. A certain relative or absolute increase in the BER can be detected in the detector 12 which on detection analogously activates the signal generator 14 in order to warn the user. As a rule, it is sufficient if, instead of monitoring the two variables of field strength and bit error rate, only one of these variables is monitored in a detector which is functionally simplified compared with the detector 12 represented in FIG. 1.

It is also conceivable in the sense of the invention that the output signal of the detector 12 is also fed back to the baseband processor 9 via a further connection 17, shown dashed. When in this case an increase in BER or a decrease in field strength is detected, this detection can be communicated to the baseband processor 9 which then transfers this information to the laptop 1 via the return channel. The information is then used in the laptop 1 for warning the user via signal sources existing in the laptop 1.

When an increase in BER or decrease in field strength is detected, the baseband processor 9 could be analogously instructed via the connection 17 to set up a Bluetooth connection to a Bluetooth-capable mobile telephone in order to warn the user via signal sources existing in the mobile telephone. This capability can be used, in particular, when there is no signal source for warning the user in the radio mouse 4 and the laptop 1 is switched off.

FIG. 2 shows a second exemplary embodiment of the invention. In this arrangement, functionally and structurally identical components have been identified with the same reference symbols as in FIG. 1. In distinction from the first exemplary embodiment according to FIG. 1, when the connection between the laptop 1 and the radio mouse 4 is terminated, such termination is detected in the baseband processor 9 and a corresponding detector circuit 19 is informed via the signal 18 characteristic of the termination of the connection. The termination of the connection is an indication that the user has switched off the laptop 1 and, after the laptop 1 has been switched off, the laptop 1 is possibly transported. In such a case, the user is warned via the arrangement according to the invention not to forget the radio mouse 4 in the transportation. The termination of the connection is detected by the sending-out of a standard-specific abortion request from the laptop 1 even before the connection is actually terminated.

The circuitry for the functionality explained by means of FIG. 1 and FIG. 2 can be implemented in many ways. For example, it is conceivable in the sense of the invention to integrate the baseband processor, the detector 12 or 19, respectively, and the generator 14 on one chip. In addition, the detector 12 or 19, respectively, can also be integrated as software function in the firmware of the baseband processor 9.

Furthermore, the arrangements according to FIG. 1 and FIG. 2 can be combined, in that the detection of the termination of the connection are performed in combination with the detection of a certain decrease in field strength and/or increase in bit error rate.

What is claimed is:

1. A method for generating a warning signal for a user of two devices which are adapted for wireless communication with one another, the first device acting as input and/or output interface between the user and the second device, the method comprising the following steps:
a) monitoring the signal strength and/or the signal quality during the communication between the two devices, wherein the signal strength or the signal quality, respectively are a variable influenced by the distance between the first device and the second device, and
b) outputting a warning signal to the user if the decrease in signal strength and/or the signal quality exceeds a predefined value in relation to a previously measured output value of the signal strength or of the signal quality, respectively, which is typical of an increase in the distance between the two devices.

2. A method as claimed in claim 1, wherein the first device and the second device are adapted to communicate with one another via a radio network.

3. A method as claimed in claim 2, wherein the radio network allows a signal transmission between the second device as transmitter and the first device as receiver.

4. A method as claimed in claim 3, wherein the step of monitoring is carried out by the first device.

5. A method as claimed in claim 2, wherein the signal strength and/or the signal quality are the field strength or bit error rate, respectively, received in the monitoring device.

6. A method as claimed in claim 2, wherein the step of outputting the warning signal is carried out by the second device.

7. A method as claimed in claim 3, wherein the step of outputting the warning signal is carried out by the first device.

8. A method as claimed in claim 2, wherein before method step b), the following step is carried out:
setting up a connection to a third device, particularly a mobile telephone, is carried out if the decrease in signal strength and/or the signal quality exceeds a predefined value in relation to a previously measured output value of the signal strength or of the signal quality, respectively, and
wherein the step of outputting the warning signal is carried out by the third device.

9. A method as claimed in claim 3, wherein the devices, which are adapted for communication by radio, operate in accordance with the Bluetooth standard.

10. A method as claimed in claim 9, wherein the first device operates as HID device and the second device operates as HID host in accordance with the Bluetooth-specific HID profile.

11. A method as claimed in claim 1, wherein the first device is a wireless radio mouse and the second device is a portable computer, particularly a laptop.

12. A method for generating a warning signal for a user of two devices which are adapted to communicate via a radio network, the first device acting as input and/or output interface between the user and the second device, comprising the following steps:
a) monitoring
of a variable characteristic of the existence of a connection between the first device and the second device and/or
of a variable influenced by the distance between the first device and the second device,
b) setting up a connection from the first device to a third device, particularly a mobile telephone, if
the variable characteristic of the existence of the connection between the first and the second device indicates a behavior typical of the termination of the connection, and/or
the variable influenced by the distance between the two devices shows a behavior typical of an increase in the distance between the first and the second device, and
c) outputting a warning signal to the user by the third device.

13. An arrangement for generating a warning signal for a user of two devices which are adapted for wireless communication with one another, the first device acting as input and/or output interface between the user and the second device, which comprises:
a) a means for monitoring the signal strength and/or the signal quality during the communication of the two devices, the signal strength or the signal quality, respectively, in each case being a variable influenced by the distance between the first device and the second device, and
b) an output means for outputting a warning signal to the user if the decrease in signal strength and/or the signal quality exceeds a predefined value in relation to a previously measured output value of the signal strength or of the signal quality, respectively, this being typical of an increase in the distance between the two devices.

14. An arrangement as claimed in claim 13, wherein the first device and the second device are adapted to communicate with one another via a radio network.

15. An arrangement as claimed in claim 14, wherein the radio network allows a signal transmission between the second device as transmitter and the first device as receiver.

16. An arrangement as claimed in claim 15, wherein the first device comprises the means for monitoring.

17. An arrangement as claimed in claim 14, wherein the means for monitoring is constructed in such a manner that it measures the field strength and/or bit error rate received in the monitoring device.

18. An arrangement as claimed in claim 14, wherein the second device comprises the output means.

19. An arrangement as claimed in claim 15, wherein the first device comprises the output means.

20. An arrangement as claimed in claim 14, comprising a third device, particularly a mobile telephone, which comprises the output means, the first device or the second device being designed for setting up a connection to the third device if the decrease in signal strength and/or the signal quality exceeds a predefined value in relation to a previously measured output value of the signal strength or of the signal quality, respectively.

21. An arrangement as claimed in claim 15, wherein the devices, which are adapted to communicate by radio, operate in accordance with the Bluetooth standard.

22. An arrangement as claimed in claim 21, wherein the first device is a HID device and the second device is a HID host in accordance with the Bluetooth-specific HID profile.

23. An arrangement as claimed in claim 13, wherein the first device is a wireless radio mouse and the second device is a portable computer, particularly a laptop.

24. An arrangement for generating a warning signal for a user of two devices adapted to communicate via a radio network, the first device acting as input and/or output interface between the user and the second device, which comprises the following:
a) a means for monitoring the signal strength and/or the signal quality during the communication between the two devices, the signal strength or the signal quality, respectively, in each case being a variable influenced by the distance between the first device and the second device, and
b) a third device, particularly a mobile telephone, which comprises an output means for outputting a warning signal to the user, the first device being constructed to set up a connection to the third device for outputting the warning signal by the third device if the decrease in signal strength and/or the signal quality exceeds a predefined value in relation to a previously measured output value of the signal strength or of the signal quality, respectively, this being typical of an increase in the distance between the two devices.
